(19) United States
(12) Patent Application Publication
(10) Pub. No.: US 2018/0149492 A1
(43) Pub. Date: May 31, 2018

(54) APPARATUS AND METHOD FOR FINDING POINT TO BE IMPROVED ON ROAD

(71) Applicant: FUJITSU LIMITED, Kawasaki-shi (JP)

(72) Inventors: Takashi Shimada, Shinagawa (JP); Hitoshi Kageyama, Edogawa (JP); Jun Tanabe, Kyoto (JP); Yoshiko Miura, Narashino (JP); Fumiaki Suzuki, Komae (JP)

(73) Assignee: FUJITSU LIMITED, Kawasaki-shi (JP)

(21) Appl. No.: 15/792,134

(22) Filed: Oct. 24, 2017

(30) Foreign Application Priority Data
Nov. 30, 2016 (JP) 2016-233569

(51) Int. Cl. G01C 21/36; G08G 1/052; G08G 1/0962; H04W 4/04

(52) U.S. Cl. CPC G01C 21/3697; H04W 4/046; G08G 1/09623; G08G 1/052

(57) ABSTRACT

A non-transitory computer-readable recording medium has stored therein a program for finding a point to be improved on a road, the program causing a s computer to execute a process including receiving driving information from a plurality of vehicles, the driving information including information on a position, a time, and a speed, and finding a road section based on the driving information of a first group of vehicles and the driving information of a second group of vehicles in a predetermined area and a predetermined period, the road section being a road section in which the speed of the vehicles in the second group of vehicles is affected by the vehicles in the first group of vehicles.

### CROSS-REFERENCE TO RELATED APPLICATION

This application is based upon and claims the benefit of priority of the prior Japanese Patent Application No. 2016-233569, filed on Nov. 30, 2016, the entire contents of which are incorporated herein by reference.

### FIELD

The embodiments discussed herein are related to an apparatus for finding a point to be improved on a road and a method for finding a point to be improved on a road.

### BACKGROUND

Hitherto, driving information including position, time, and speed has been received using digital tachographs mounted on commercial vehicles and car navigation systems mounted on passenger cars. There have been proposed methods for finding dangerous points on the roads using the received driving information.

For example, there has been proposed a method of specifying a point of frequent sudden braking based on the driving information and warning the driver at an appropriate timing (see, for example, Japanese Laid-open Patent Publication (JP-A) No. 2015-194939).

### SUMMARY

According to one aspect of the present disclosure, a non-transitory computer-readable recording medium has stored therein a program for finding a point to be improved on a road, the program causing a computer to execute a process including receiving driving information from a plurality of vehicles, the driving information including information on a position, a time, and a speed, and finding a road section based on the driving information of a first group of vehicles and the driving information of a second group of vehicles in a predetermined area and a predetermined period, the road section being a road section in which the speed of the vehicles in the second group of vehicles is affected by the vehicles in the first group of vehicles.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration of a system including an apparatus for finding a point to be improved on a road according to an embodiment of the present disclosure;

FIG. 2 is a diagram illustrating an example of categories of vehicles classified based on Japan Road Traffic Act;

FIG. 3 is a diagram illustrating an example of categories of vehicles on driver's licenses;

FIG. 4 is a diagram illustrating an example of a screen displaying a road map for allowing designating an area from which a road section is to be found, by enclosing that area within a rectangle;

FIG. 5 is a diagram illustrating an example of a function configuration of a driving information management server;

FIG. 6 is a diagram illustrating an example of driving information;

FIG. 7 is a diagram illustrating an example of a hardware configuration of a driving information management server;

FIG. 8 is a diagram illustrating an example of a function configuration of an apparatus for finding a point to be improved on a road;

FIG. 9 is a diagram illustrating an example of how a management unit is set;

FIG. 10 is a diagram illustrating an example of management unit information;

FIG. 11 is a graph of an example of a result of calculating the average speeds of vehicles in a first group of vehicles and a second group of vehicles;

FIG. 12 is a graph of an example of a result of calculating standard deviations of the speeds of vehicles in a first group of vehicles and a second group of vehicles;

FIG. 13 is a graph of an example of a result of calculating standard deviation of the speed of only vehicles in the second group of vehicles;

FIG. 14 is a diagram illustrating an example of calculated values of the average speeds and standard deviations of the speeds of vehicles in a first group of vehicles and a second group of vehicles;

FIG. 15 is a diagram illustrating an example of a screen displaying road sections found based on FIG. 11 on a road map;

FIG. 16 is a diagram illustrating an example of a screen displaying road sections found based on FIG. 12 on a road map;

FIG. 17 is a diagram illustrating an example of a screen displaying road sections found based on FIG. 13 on a road map;

FIG. 18 is a diagram illustrating an example of a hardware configuration of an apparatus for finding a point to be improved on a road; and

FIG. 19 is a flowchart illustrating an example of a flow of performing control for finding a road section at a high occurrence likelihood of an accident or a traffic jam and displaying the road section on a road on a road map.

### DESCRIPTION OF EMBODIMENTS

According to the method described in JP-A No. 2015-194939, dangerous points on the roads include not only points of frequent sudden braking, but also, for example, single-lane uphills without passing lanes, where standard-sized vehicles easily catch up with heavily-loaded slow trucks and hence may force overtaking or slow down the speed to avoid rear-end collision, to constitute a cause for an accident or a traffic jam. There are cases where it is difficult to detect these kinds of dangerous points because no abrupt speed changes such as sudden braking occur.

Furthermore, on trunk roads that include more than one lanes but have a heavy traffic volume of large-sized motor vehicles, for example, lane changes forced when slow trucks are running ahead may often cause an accident or a traffic jam.

There are also cases where it is difficult to detect these kinds of dangerous points because no abrupt speed changes such as sudden braking occur.

In one aspect, the present disclosure has an object to provide a non-transitory computer-readable recording medium having stored therein a program for finding a point to be improved on a road, an apparatus for finding a point to be improved on a road, and a method for finding a point to be improved on a road, the non-transitory computer-readable recording medium, the apparatus, and the method being capable of finding a road section that is at a high occurrence likelihood of an accident or a traffic jam.

It is possible to find a road section that is at a high occurrence likelihood of an accident or a traffic jam.

An embodiment of the present disclosure will be described below. However, the present disclosure should not be construed as being limited to this embodiment.

Control being performed by each part of a control part of the disclosed “apparatus for finding a point to be improved on a road” (hereinafter may also be referred to as “driving information management server”) has the same meaning as the disclosed “method for finding a point to be improved on a road” being carried out. Therefore, details of the disclosed “method for finding a point to be improved on a road” will also be specified through description of the disclosed “apparatus for finding a point to be improved on a road”. Further, the “a program for finding a point to be improved on a road” is realized as the disclosed “apparatus for finding a point to be improved on a road” with the use of, for example, computers as hardware resources. Therefore, details of the disclosed “non-transitory computer-readable recording medium having stored therein a program for finding a point to be improved on a road” will also be specified through description of the disclosed “apparatus for finding a point to be improved on a road”.

The program for finding a point to be improved on a road is stored in a recording medium. This enables the program for finding a point to be improved on a road to be installed in, for example, a computer. The recording medium having stored therein the program for finding a point to be improved on a road is a non-transitory recording medium. The non-transitory recording medium is not particularly limited and may be appropriately selected depending on the intended purpose. Examples of the non-transitory recording medium include a CD-ROM (Compact Disc-Read Only Memory) and a DVD-ROM (Digital Versatile Disc-Read Only Memory).

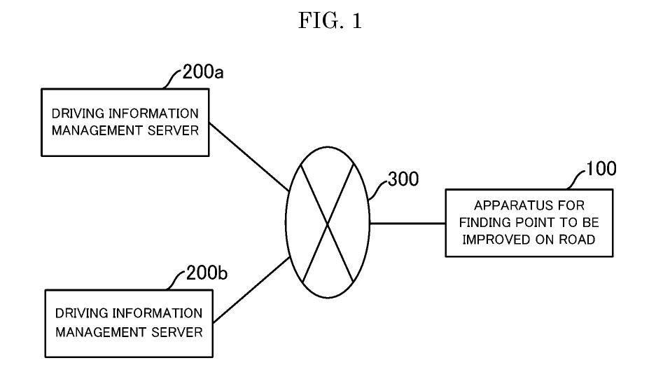

FIG. 1 is a diagram illustrating a configuration of a system including an apparatus 100 for finding a point to be improved on a road according to an embodiment of the present disclosure. The apparatus 100 for finding a point to be improved on a road includes a built-in program for finding a point to be improved on a road. When the apparatus 100 for finding a point to be improved on a road is worked, the method for finding a point to be improved on a road is performed.

As illustrated in FIG. 1, the system including the apparatus 100 for finding a point to be improved on a road includes the apparatus 100 for finding a point to be improved on a road and driving information management servers 200a and 200b. The apparatus 100 for finding a point to be improved on a road and the driving information management servers 200a and 200b are communicably connected to one another via a network 300.

The driving information management servers 200a and 200b are configured to collect from various vehicles including large-sized motor vehicles (hereinafter may also be referred to as “large-sized vehicles”) such as trucks and standard-sized motor vehicles (hereinafter may also be referred to as “standard-sized vehicles”), driving information including information on a position, a time, and a speed, sent from the respective vehicles at predetermined time intervals, and send the driving information to the apparatus 100 for finding a point to be improved on a road.

The apparatus 100 for finding a point to be improved on a road is configured to find a road section in which the speed of vehicles in a second group of vehicles is affected by vehicles in a first group of vehicles based on the driving information of the first group of vehicles and the driving information of the second group of vehicles in a predetermined area and a predetermined period. The apparatus 100 for finding a point to be improved on a road may also be configured to display the found road section on a screen displaying a road map.

A road section refers to a section of a road that may be a single-lane road or a multilane road.

The vehicles in the first group of vehicles are vehicles that are classified as running at a speed relatively lower than the speed of the vehicles in the second group of vehicles. That is, the vehicles in the first group of vehicles are vehicles that tend to have a speed difference from the vehicles in the second group of vehicles. In the present embodiment, classification into the first group of vehicles or the second group of vehicles is based on the vehicle weight. For example, vehicles that have a maximum loading capacity of 4 tons or greater or have a gross vehicle weight of 7 tons or greater are classified into the first group of vehicles. The vehicles in the second group of vehicles are vehicles classified as running at a speed higher than the running speed of the vehicles in the first group of vehicles. In the present embodiment, the vehicles in the second group of vehicles are vehicles other than the vehicles in the first group of vehicles.

Classification may be based not only on weight but on engine performance value. The vehicles in the first group of vehicles may also be referred to as “commercial vehicles”.

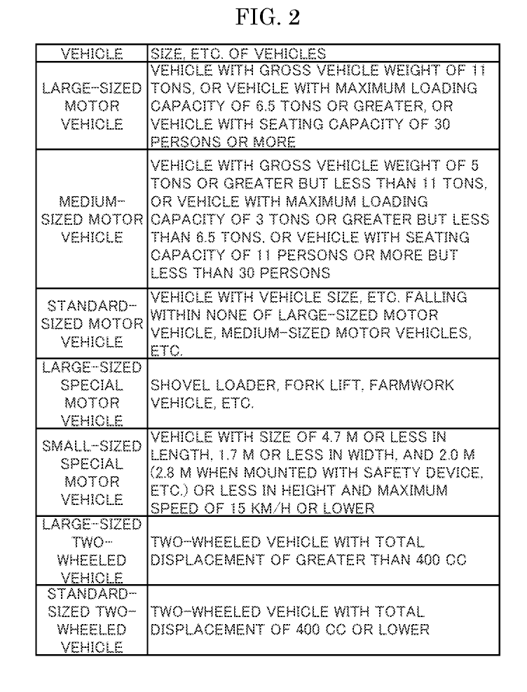

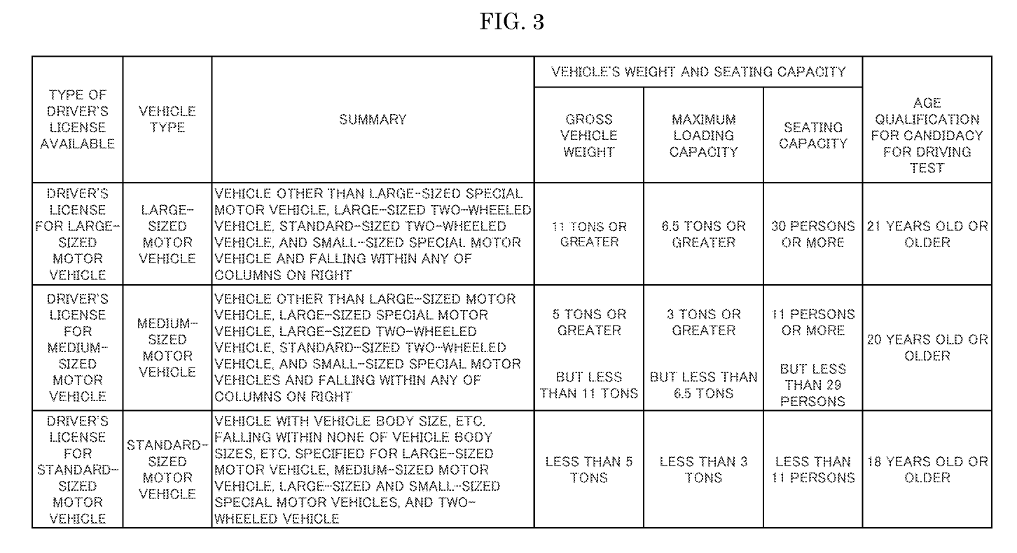

The vehicle types classified into the first group of vehicles and the second group of vehicles are not limited to the above, but may be, for example, the categories classified based on so called Japan Road Traffic Act or Japan Road Transport Vehicle Act or the categories on driver's licenses. As illustrated in FIG. 2, the categories classified based on Japan Road Traffic Act include large-sized motor vehicle, medium-sized motor vehicle, standard-sized motor vehicle, large-sized special motor vehicle, small-sized special motor vehicle, large-sized two-wheeled vehicle, and standard-sized two-wheeled vehicle. The vehicle types classified based on Japan Road Transport Vehicle Act include standard-sized motor vehicle, small-sized motor vehicle, light-duty motor vehicle, large-sized special motor vehicle, and small-sized special motor vehicle. As illustrated in FIG. 3, the categories on driver's licenses include large-sized motor vehicle, medium-sized motor vehicle, and standard-sized motor vehicle.

The method for classification into the first group of vehicles and the second group of vehicles is not particularly limited and may be appropriately selected depending on the intended purpose. Examples of the method include a method of associating with the driving information, vehicle information (e.g., as gross vehicle weight and maximum loading capacity) that allows determination of whether or not the vehicle is a vehicle in the first group of vehicles, and classifying the vehicle with reference to the vehicle information.

The apparatus 100 for finding a point to be improved on a road finds a road section in which the speed of the vehicles in the second group of vehicles is affected by the vehicles in the first group of vehicles based on the driving information of the first group of vehicles and the driving information of the second group of vehicles in a predetermined area and a predetermined period in which, for example, a road manager wants to find the road section.

In order to find a road section in which the speed of the vehicles in the second group of vehicles is affected by the vehicles in the first group of vehicles, the apparatus 100 for finding a point to be improved on a road first distributes the driving information of each vehicle to corresponding management units of the road divided at, for example, every 50 meters, and calculates the average speed of the vehicles in the first group of vehicles, the average speed of the vehicles in the second group of vehicles, standard deviation of the speed of the vehicles in the first group of vehicles, and standard deviation of the speed of the vehicles in the second group of vehicles, in each of the management units. Next, the apparatus 100 for finding a point to be improved on a road determines whether or not a management unit is one in which the speed of the vehicles in the second group of vehicles is affected by the vehicles in the first group of vehicles based on the calculated average speeds and standard deviations of the speeds of the vehicles in the first group of vehicles and the vehicles in the second group of vehicles, and finds a management unit in which the speed of the vehicles in the second group of vehicles is determined to be affected by the vehicles in the first group of vehicles.

The method for finding a road section in which the speed of the vehicles in the second group of vehicles is affected by the vehicles in the first group of vehicles is not particularly limited and may be appropriately selected depending on the intended purpose. In the present embodiment, management units to be found are management units in which (1) the difference between the average speed of the vehicles in the first group of vehicles and the average speed of the vehicles in the second group of vehicles is equal to or less than a predetermined value, (2) the difference between the standard deviation of the vehicles in the first group of vehicles and the standard deviation of the vehicles in the second group of vehicles is equal to or less than a predetermined value, and (3) the standard deviation of the speed of the vehicles in the second group of vehicles is equal to or greater than a predetermined value, according to the driving information in the area and period designated by, for example, the road manager. (1) to (3) will be described below.

(1) When the difference between the average speed of the vehicles in the first group of vehicles and the average speed of the vehicles in the second group of vehicles is equal to or less than a predetermined value, an assumable state is a state where standard-sized vehicles have caught up with slow trucks and are running at similar speeds to the trucks particularly on a single-lane road because the speed of the standard-sized vehicles is restricted. Therefore, the apparatus 100 for finding a point to be improved on a road finds a management unit in which the difference between the average speed of the vehicles in the first group of vehicles and the average speed of the vehicles in the second group of vehicles is equal to or less than a predetermined value, as a road section that is at a high occurrence likelihood of an accident or a traffic jam due to, for example, forcible overtaking or lane change. When performing the finding described above, the apparatus 100 for finding a point to be improved on a road may refer to a plurality of sections and find a case where a section in which the difference between the average speed of the vehicles in the first group of vehicles and the average speed of the vehicles in the second group of vehicles is equal to or greater than a predetermined value shifts to a section in which the difference between the average speed of the vehicles in the first group of vehicles and the average speed of the vehicles in the second group of vehicles is equal to or less than the predetermined value. When performing the finding described above, the apparatus 100 for finding a point to be improved on a road may also find a section in which the average speed of the vehicles in the first group of vehicles and the average speed of the vehicles in the second group of vehicles are both higher than predetermined speeds.

(2) When the difference between the standard deviation of the vehicles in the first group of vehicles and the standard deviation of the vehicles in the second group of vehicles is equal to or less than a predetermined value, a state where standard-sized vehicles have caught up with slow trucks and are running at similar speeds to the trucks particularly on a single-lane road because the speed of the standard-sized vehicles is restricted is often assumable. Therefore, the apparatus 100 for finding a point to be improved on a road finds a management unit in which the difference between the standard deviation of the vehicles in the first group of vehicles and the standard deviation of the vehicles in the second group of vehicles is equal to or less than a predetermined value, as a road section that is at a high occurrence likelihood of an accident or a traffic jam due to, for example, forcible overtaking.

(3) When the standard deviation of the speed of the vehicles in the second group of vehicles is equal to or greater than a predetermined value, a state where standard-sized vehicles have caught up with slow trucks and the speed of the standard-sized vehicles is restricted is assumed to be frequent. Therefore, the apparatus 100 for finding a point to be improved on a road finds a management unit in which the standard deviation of the speed of the vehicles in the second group of vehicles is equal to or greater than a predetermined value, as a road section that is at a high occurrence likelihood of an accident or a traffic jam due to, for example, forcible overtaking.

In this way, finding of a road section in which the speed of the vehicles in the second group of vehicles is affected by the vehicles in the first group of vehicles allows identifying of a road section that is at a high occurrence likelihood of an accident or a traffic jam. Therefore, determination of a road section to be worked for improvement can be facilitated.

In the present embodiment, a road section in which the speed of the vehicles in the second group of vehicles is affected by the vehicles in the first group of vehicles is found by calculating and comparing the average speeds or the standard deviations of the speeds of both of the groups of vehicles. This is non-limiting. For example, the medians or variances of the speeds of the vehicles in both of the groups of vehicles may be compared.

Next, details of the system including the apparatus 100 for finding a point to be improved on a road will be described by presenting an example in which the apparatus 100 for finding a point to be improved on a road finds a road section in which the speed of the vehicles in the second group of vehicles is affected by the vehicles in the first group of vehicles based on driving information collected from the road illustrated in FIG. 4. In FIG. 4, a bold line represents a two-lane section and a thin line represents a single-lane section.

In the present embodiment, vehicles mounted with driving information receiving terminals of the driving information management server 200a are large-sized motor vehicles, and the time interval at which the driving information management server 200a receives driving information is one second. Vehicles mounted with driving information receiving terminals of the driving information management server 200b are standard-sized motor vehicles, and the time interval at which the driving information management server 200b receives driving information is three seconds.

The driving information management servers 200a and 200b have the same function configuration and hardware configuration except for the time interval at which driving information is received and the vehicles mounted with their driving information receiving terminals. Therefore, the driving information management servers 200a and 200b will be described collectively as driving information management server(s) 200.

In the present embodiment, the two driving information management servers 200a and 200b are communicably connected to the apparatus 100 for finding a point to be improved on a road as the driving information management servers 200. This is non-limiting. There may be one driving information management server or two or more driving information management servers.

<<Function Configuration of Driving Information Management Server>>

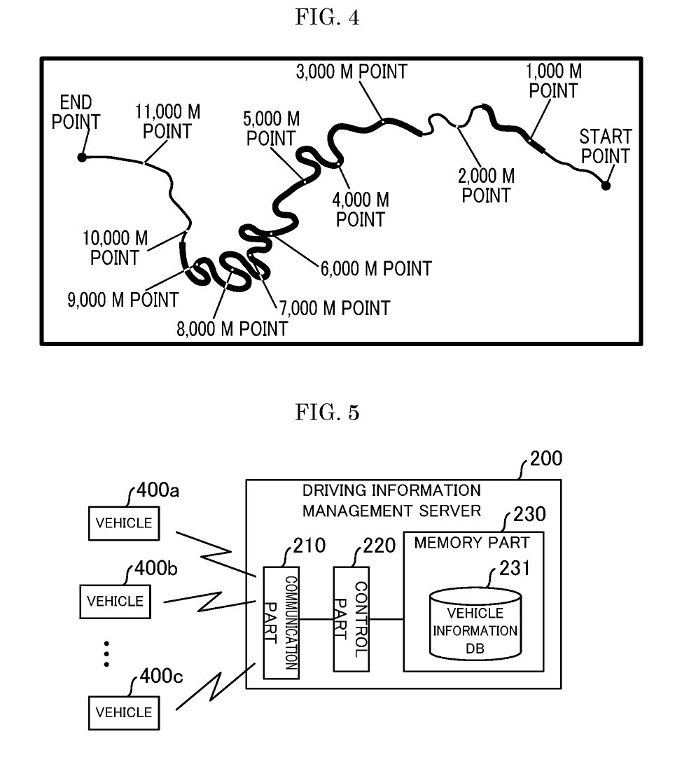

FIG. 5 is a diagram illustrating an example of a function configuration of the driving information management server 200. As illustrated in FIG. 5, the driving information management server 200 includes a communication part 210, a control part 220, and a memory part 230.

The driving information management server 200 is an apparatus configured to daily collect driving information from driving information receiving terminals mounted on vehicles 400a, 400b, and 400c. The control part 220 is configured to control the communication part 210 to send the driving information of each vehicle received by the communication part 210 to the apparatus 100 for finding a point to be improved on a road.

Examples of the driving information receiving terminals mounted on the vehicles 400a, 400b, and 400c respectively include digital tachographs mounted on trucks and taxis and car navigation systems mounted on passenger cars and capable of performing communication. In the present embodiment, the driving information receiving terminal includes a GPS (Global Positioning System) unit and a speed sensor that is mounted on an axle of a vehicle. The driving information receiving terminal is configured to associate information on a position and information on a speed, which are obtained by synchronizing the GPS unit and the speed sensor with each other, with information on a time at which the GPS unit and the speed sensor are synchronized.

In the present embodiment, upon receipt of driving information, the driving information management server 200 associates the driving information with vehicle information pre-stored in a vehicle information database 231 of the memory part 230 based on a terminal ID included in the driving information, and sends the driving information to the apparatus 100 for finding a point to be improved on a road.

The driving information receiving terminal may include the vehicle information database 231, so that the driving information receiving terminal may associate the driving information with the vehicle information. Alternatively, the apparatus 100 for finding a point to be improved on a road may include the vehicle information database 231, so that the apparatus 100 for finding a point to be improved on a road may associate the driving information with the vehicle information. Hereinafter, a database may also be referred to as DB (Database).

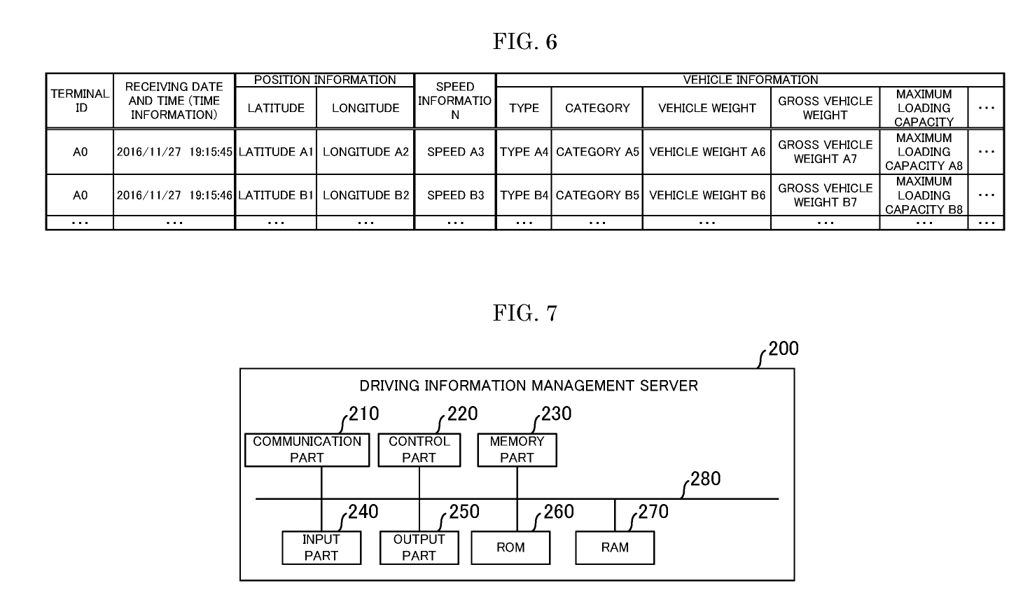

FIG. 6 is a diagram illustrating an example of the driving information. As illustrated in FIG. 6, in the present embodiment, items including “terminal ID, time information, position information, speed information, and vehicle information” are stored in association with one another as the driving information.

The “terminal ID” is a code used for identification of a driving information receiving terminal.

The “time information” is information on a time at which position information and speed information are obtained by synchronizing the GPS unit and the speed sensor with each other.

The “position information” is information on the longitude and latitude measured by the GPS unit.

The “speed information” is a measured speed measured by the speed sensor installed on an axle.

The “vehicle information” is information on a vehicle mounted with the driving information receiving terminal, and includes information on, for example, the type of the vehicle, category, vehicle weight, gross vehicle weight, and maximum loading capacity. The vehicle information is not limited to the above, and may include information on, for example, the overall length, overall width, and overall height of the vehicle.

The present embodiment has been described with an example in which five kinds of driving information, i.e., terminal ID, time information, position information, speed information, and vehicle information are used. However, this is non-limiting.

<<Hardware Configuration of Driving Information Management Server>>

FIG. 7 is a diagram illustrating an example of a hardware configuration of the driving information management server 200. As illustrated in FIG. 7, the driving information management server 200 includes the communication part 210, the control part 220, the memory part 230, an input part 240, an output part 250, a ROM (Read Only Memory) 260, and a RAM (Random Access Memory) 270. The parts of the driving information management server 200 are communicably connected to each other via a bus 280.

The communication part 210 is configured to receive driving information from the driving information receiving terminal mounted on each vehicle, for example, wirelessly, based on an instruction from the control part 220. The communication part 210 is also configured to send the driving information to the apparatus 100 for finding a point to be improved on a road via the network 300 based on an instruction from the control part 220.

The control part 220 is configured to execute various programs stored in the memory part 230 and control the driving information management server 200 on the whole.

Examples of the control part 220 include a CPU (Central Processing Unit).

The memory part 230 is configured to store, for example, various programs installed in the driving information management server 200 and data generated by execution of the programs, based on an instruction from the control part 220.

The memory part 230 is not particularly limited and may be appropriately selected depending on the intended purpose. Examples of the memory part 230 include a solid state drive, a hard disk drive, and portable memory devices such as a CD (Compact Disc) drive, a DVD (Digital Versatile Disc) drive, and a BD (Blu-ray (registered trademark) Disc) drive. The memory part 230 may be a part of a cloud, which is a group of computers on a network.

The input part 240 is, for example, a keyboard, a mouse, or a touch panel, and is configured to receive various instructions to the driving information management server 200 based on an instruction from the control part 220.

The output part 250 is, for example, a display or a speaker, and is configured to display an internal status of the driving information management server 200 based on an instruction from the control part 220.

The ROM 260 stores, for example, various programs and data necessary for the control part 220 to execute the various programs stored in the memory part 230. Specifically, the ROM 260 stores a boot program such as a BIOS (Basic Input/Output System) and an EFI (Extensible Firmware Interface).

The RAM 270 is a main memory device, and is configured to function as a work area to be developed when the various programs stored in the memory part 230 are executed by the control part 220. Examples of the RAM 270 include a DRAM (Dynamic Random Access Memory) and an SRAM (Static Random Access Memory).

(Apparatus for Finding Point to be Improved on Road)

<Function Configuration of Apparatus for Finding Point to be Improved on Road>

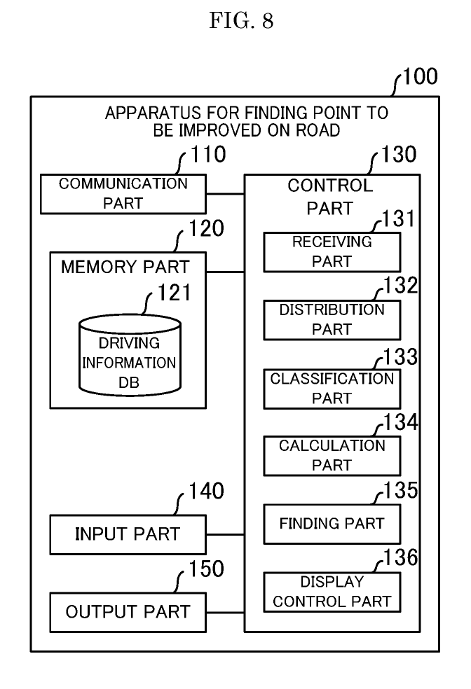

FIG. 8 is a diagram illustrating an example of a function configuration of the apparatus 100 for finding a point to be improved on a road. As illustrated in FIG. 8, the apparatus 100 for finding a point to be improved on a road includes a communication part 110, a memory part 120, a control part 130, an input part 140, and an output part 150.

<<Communication Part>>

The communication part 110 is configured to output an instruction to the control part 220 of the driving information management servers 200 to send driving information based on an instruction from the control part 130, and receive driving information from the driving information management servers 200a and 200b.

When receiving driving information, in order to specify the sender, it is preferable to confirm that the sender is the proper information generator, or that the information has not been falsified, using, for example, a known electronic signature technology. Alternatively, it is preferable to confirm that the sender is the proper information generator, and that the information has not been falsified, using, for example, a known electronic signature technology. It is more preferable to manage the deadline for information exchange, and to reject receiving information after a predetermined time period has passed.

The communication part 110 may receive the information at any time, or, for example, the road manager may manually collect the information from the driving information receiving terminal and the driving information management server 200.

<<Memory Part>>

The memory part 120 includes a driving information DB 121, and the driving information received by the communication part 110 is stored in the driving information DB 121.

The memory part 120 is configured to store, for example, various programs installed in the apparatus 100 for finding a point to be improved on a road and data generated by execution of the programs, based on an instruction from the control part 130.

<<Control Part>>

The control part 130 includes a receiving part 131, a distribution part 132, a classification part 133, a calculation part 134, a finding part 135, and a display control part 136.

The control part 130 is configured to read from the driving information DB 121 of the memory part 120, driving information in a designated area and a designated period from driving information stored in the driving information DB 121.

—Receiving Part—

The receiving part 131 is configured to send an instruction to the control part of the driving information management server 200 and store driving information sent from the driving information management server 200 in the driving information DB 121.

In the present embodiment, the receiving part 131 outputs an instruction to the control part 220 of the driving information management server 200, and the driving information management server 200 sends driving information. This is non-limiting. The driving information management server 200 may send information without an instruction from the receiving part 131.

—Distribution Part—

The distribution part 132 is configured to distribute driving information varied in position information vehicle by vehicle, to corresponding management units each defined by a predetermined latitude range and a predetermined longitude range of a road, in order to determine the number of sample data for calculating average speed and standard deviation of speed for each point of the road. In the present embodiment, driving information is distributed to corresponding management units obtained by dividing the road at every 50 meters.

When driving information is obtained, for example, based on different units, within different periods, and by different organizations, and stored in different driving information management servers, it is necessary to distribute the driving information to corresponding management units employed by the apparatus 100 for finding a point to be improved on a road in order to find a road section that is at a high occurrence likelihood of an accident or a traffic jam. By the distribution part 132 performing such distribution of driving information, it is possible to manage driving information for each of the management units.

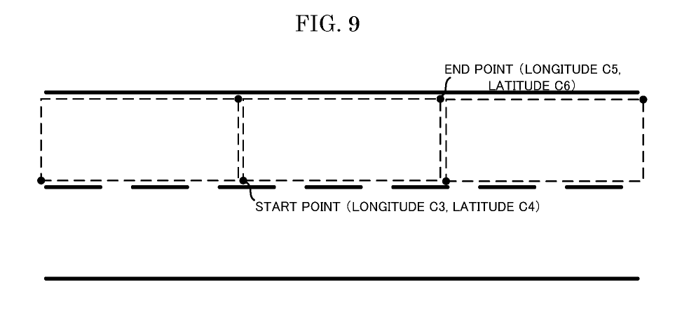

As used herein, the management unit refers to a unit by which the road state is managed for each lane. As illustrated in FIG. 9, the management unit is represented as a rectangle on a lane of a road map, and is defined by setting position information of latitudes and longitudes of two points on the rectangle, namely opposite vertices (start point and end point). This enables found road sections to be displayed in a manner to correspond to a road on the road map based on the management units. This makes it possible to know the road sections at a glance.

The range of the rectangle is not particularly limited and may be appropriately selected depending on the intended purpose. For example, when the unit by which an order for work is placed is 100 meters, the length of the longer side of the rectangular ranges may be set to 100 meters uniformly, or may be set based on the distance mark (kilometer post). It is preferable to set the management units independently for each lane of the road.

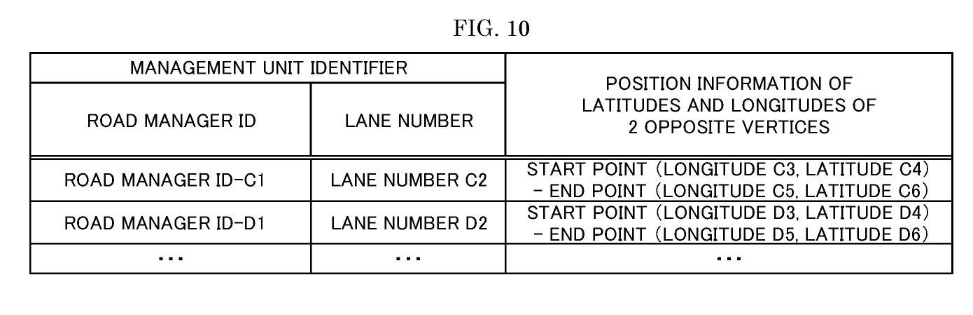

FIG. 10 is a diagram illustrating an example of management unit information. As illustrated in FIG. 10, “a road manager ID, a lane number, and position information of latitudes and longitudes of two opposite vertices” are stored in association with one another as the management unit information.

The “road manager ID” is an identifier identifying a road manager. The road manager may be, for example, a national highway office or a road manager of, for example, a prefecture.

The “lane number” is an identifier identifying a lane uniquely

The “position information of latitudes and longitudes of two opposite vertices” defines the range of the management unit by setting “start point” and “end point”. As the settings of the position information of latitudes and longitudes of two opposite vertices, the “start point” is position information indicating a start position of the management unit, and is specified by a latitude and a longitude thereof. The “end point” is position information indicating an end position of the management unit, and is specified by a latitude and a longitude thereof.

The distribution part 132 is configured to distribute driving information received by the receiving part 131 to corresponding management units and store the driving information in the driving information DB 121 of the memory part 120. Therefore, even if there are different time intervals at which driving information is received, it is possible to calculate, for example, average speed and standard deviation of each management unit, by, based on position information including a latitude and longitude included in each driving information, managing in mutual association, driving information that includes the position information indicating a position that is included within the longitude/latitude ranges of a management unit.

—Classification Part—

The classification part 133 is configured to classify the vehicles that are identified by the driving information stored in the driving information DB 121 and that are in a predetermined area and a predetermined period designated by, for example, the road manager, into the first group of vehicles and the second group of vehicles.

In the present embodiment, the classification part 133 can classify the vehicles into the first group of vehicles and the second group of vehicles after the distribution part 132 distributes the driving information to the corresponding management units. However, the order may be reversed.

—Calculation Part—

The calculation part 134 is configured to calculate, for each of the management units, the average speed or standard deviation of the speed of the vehicles classified by the classification part 133 into either group of vehicles.

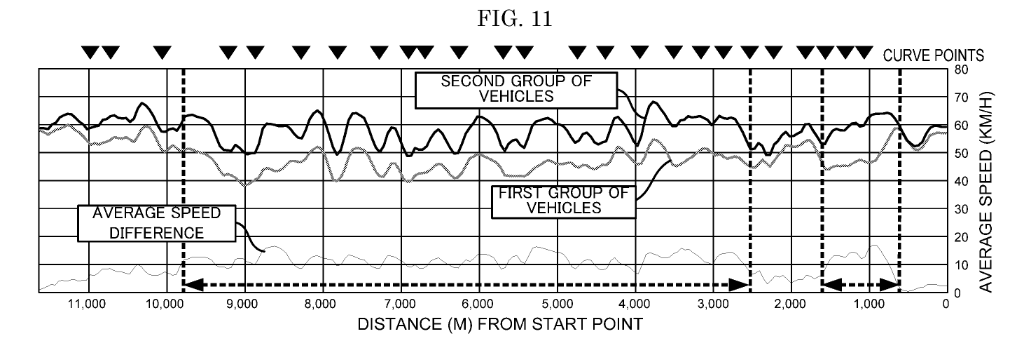

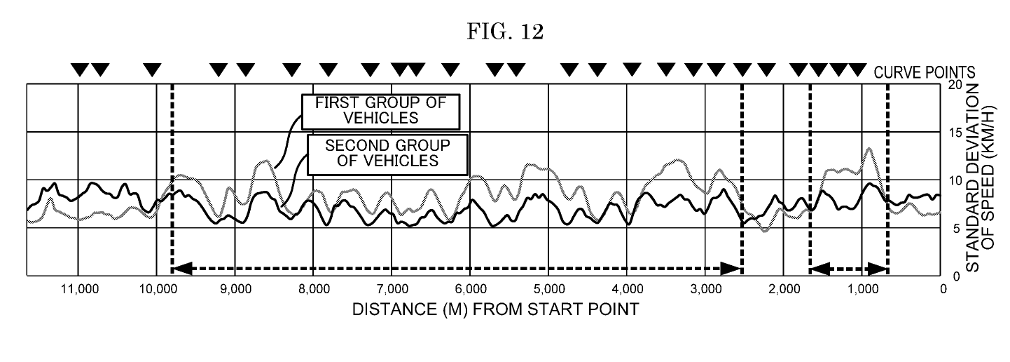

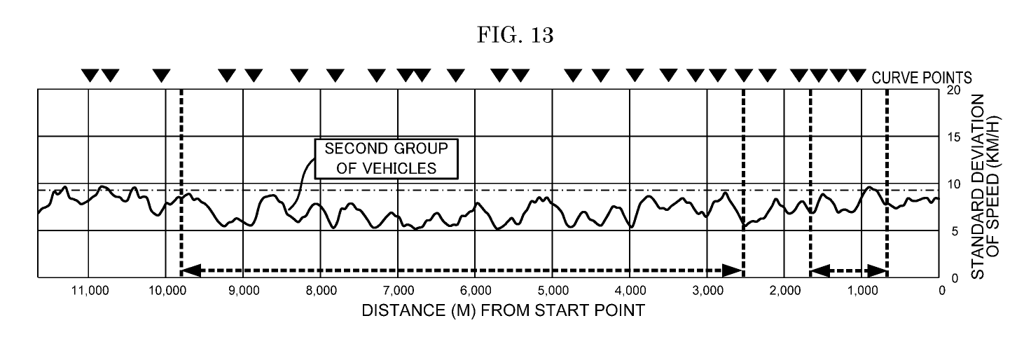

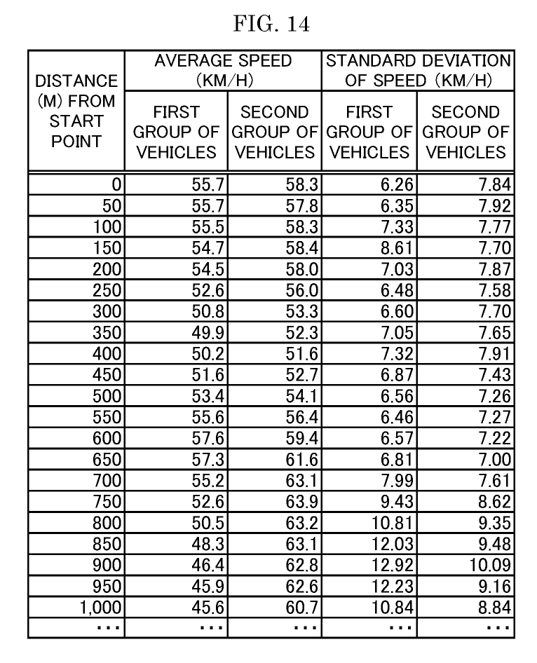

FIG. 11 is a graph of an example of a result of calculating the average speeds of the vehicles in the first group of vehicles and the second group of vehicles. FIG. 12 is a graph of an example of a result of calculating the standard deviations of the speeds of the vehicles in the first group of vehicles and the second group of vehicles. FIG. 13 is a graph of an example of a result of calculating the standard deviation of the speed of only the vehicles in the second group of vehicles. FIG. 14 is a diagram illustrating an example of calculated values of the average speeds and standard deviations of the speeds of the vehicles in the first group of vehicles and the second group of vehicles, and presents the values calculated for from the start point to 1,000 meters.

In FIG. 11 to FIG. 13, a vertical axis represents average speed or standard deviation of speed and a horizontal axis represents distance from the start point. A pale bold line represents the first group of vehicles, a dark bold line represents the second group of vehicles, sections indicated by dashed arrows are two-lane sections, and triangle marks above the graph indicate curve points. In FIG. 11, a thin line represents the difference between the average speed of the vehicles in the first group of vehicles and the average speed of the vehicles in the second group of vehicles. The driving information in FIG. 11 to FIG. 13 is received in all time slots (24 hours). The number of samples in the first group of vehicles is 667 vehicles and the number of samples in the second group of vehicles is 729 vehicles.

In FIG. 11, it can be seen that the average speed of the vehicles in the first group of vehicles and the average speed of the vehicles in the second group of vehicles are close to each other at many points in sections other than the two-lane sections. In FIG. 12, it can be seen that there are many cases where the order of which of the standard deviation of the speed of the vehicles in the first group of vehicles and the standard deviation of the speed of the vehicles in the second group of vehicles is higher than the other in the sections other than the two-lane sections is reversed from the order in the two-lane sections. In FIG. 13, it can be seen that points at which the standard deviation of the speed of the vehicles in the second group of vehicles becomes higher are present in a section other than the two-lane sections.

—Finding Part—

The finding part 135 is configured to find a road section in which the speed of the vehicles in the second group of vehicles is affected by the vehicles in the first group of vehicles, based on the driving information of the first group of vehicles and the driving information of the second group of vehicles in a predetermined area and a predetermined period designated by, for example, the road manager. In the present embodiment, the finding part 135 finds management units in which (1) the difference between the average speed of the vehicles in the first group of vehicles and the average speed of the vehicles in the second group of vehicles is 7 km/h or less, (2) the value obtained by subtracting the standard deviation of the vehicles in the first group of vehicles from the standard deviation of the vehicles in the second group of vehicles is 0 km/h or less, and (3) the standard deviation of the speed of the vehicles in the second group of vehicles is 9 km/h or greater in FIG. 11 to FIG. 13.
It is preferable that the found management units, i.e., the found road sections be displayed by the display control part 136 in the manner described below.

—Display Control Part—

The display control part 136 is configured to perform control for displaying the found road sections on a road map in order to inform, for example, the road manager that the road sections found by the finding part 135 are at a high occurrence likelihood of an accident or a traffic jam. The display control section 136 is also capable of displaying the found road sections on a user terminal or the driving information management server.

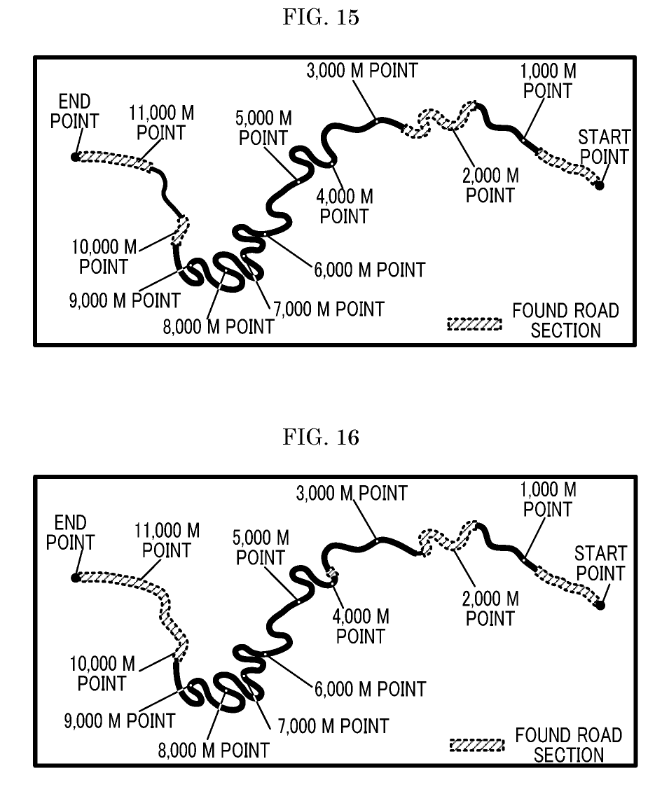

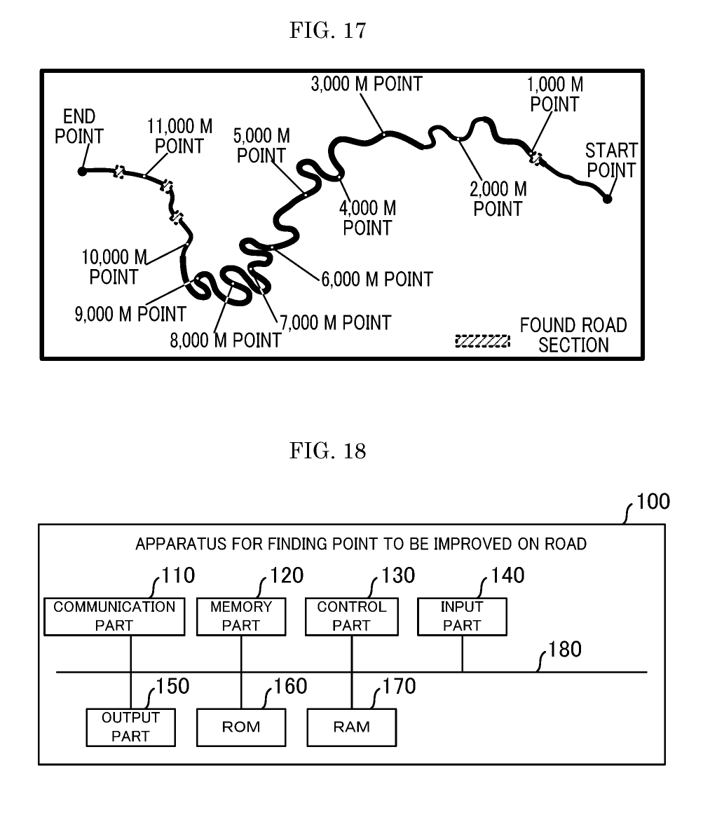

FIG. 15 to FIG. 17 are diagrams illustrating examples of a screen displaying road sections found based on FIG. 11 to FIG. 13 on a road map. In FIG. 15 to FIG. 17, the found road sections are represented as hatched sections.

The results that are obtained by the finding methods of (1) to (3) and illustrated in FIG. 15 to FIG. 17 may be displayed in a superimposition manner on the screen.

Performing the control for finding road sections that are at a high occurrence likelihood of an accident or a traffic jam and displaying the road sections on a road map in this way makes it possible to known road sections that are at a high occurrence likelihood of an accident or a traffic jam at a glance. Therefore, for example, the road manager can determine with ease whether a road improvement work for preventing occurrence of an accident or a traffic jam is necessary or not.

The input part 140 is configured to receive an input designating an area and a period in which it is desired to find road sections from, for example, the road manager. In the present embodiment, as illustrated in FIG. 4, enclosing an area from which it is desired to find road sections within a rectangle on a road map displayed on the screen effects designation of the area from which it is desired to find road sections.

It is also possible to enter, for example, management unit information, and other various kinds of information to the input part 140.

The output part 150 is, for example, a display in the present embodiment, and is configured to display to, for example, the road manager, found road sections on a road map and other various kinds of information on the road map. The output part 150 is also configured to display an internal status of the apparatus 100 for finding a point to be improved on a road.

<Hardware Configuration of Apparatus for Finding Point to be Improved on Road>

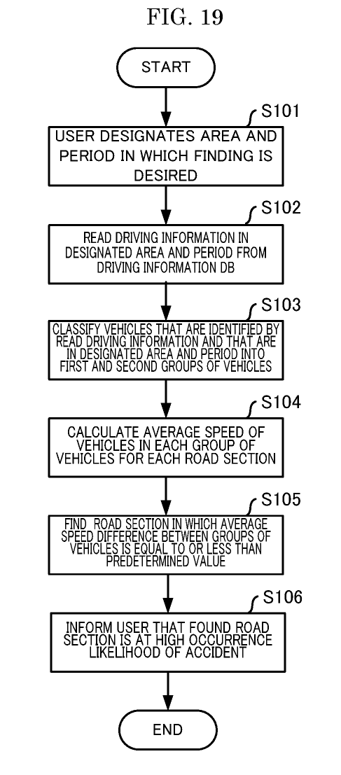

FIG. 18 is a diagram illustrating an example of a hardware configuration of the apparatus 100 for finding a point to be improved on a road. As illustrated in FIG. 18, the apparatus 100 for finding a point to be improved on a road includes the communication part 110, the memory part 120, the control part 130, the input part 140, the output part 150, a ROM 160, and a RAM 170. The parts of the apparatus 100 for finding a point to be improved on a road are communicably connected to one another via a bus 180.

The communication part 110 is configured to receive driving information from the driving information management servers 200a and 200b illustrated in FIG. 1 based on an instruction from the control part 130.

In the present embodiment, the communication part 110 is configured to receive driving information based on an instruction from the control part 130. However, the communication part 110 may output an instruction via the network 300 to the driving information management servers 200a and 200b to send driving information.

The memory part 120 is not particularly limited and may be appropriately selected depending on the intended purpose. Examples of the memory part 120 include a solid state drive, a hard disk drive, and portable memory devices such as a CD drive, a DVD drive, and a BD drive. The memory part 120 may be a part of a cloud, which is a group of computers on a network.

The control part 130 is configured to execute various programs stored in the memory part 120 and control the apparatus 100 for finding a point to be improved on a road on the whole.

Examples of the control part 130 include a processor such as a CPU. The control part 130 is configured to execute the processes of the apparatus 100 for finding a point to be improved on a road on the whole. The processor that executes software is hardware.

The input part 140 is not particularly limited and may be appropriately selected depending on the intended purpose. Examples of the input part 140 include a keyboard, a mouse, and a touch panel.

The output part 150 is not particularly limited and may be appropriately selected depending on the intended purpose. Examples of the output part 150 include a display and a speaker.

The ROM 160 is configured to store, for example, various programs and data necessary for the control part 130 to execute various programs stored in the memory part 120.

The RAM 170 is a main memory device, and is configured to function as a work area to be developed when the various programs stored in the memory part 120 are executed by the control part 130. Examples of the RAM 170 include a DRAM and an SRAM.

FIG. 19 is a flowchart illustrating an example of a flow for the apparatus 100 for finding a point to be improved on a road to perform control for finding road sections that are at a high occurrence likelihood of an accident or a traffic jam and displaying the road sections on a road on a road map. Control, by the apparatus 100 for finding a point to be improved on a road, for displaying road sections that are at a high occurrence likelihood of an accident or a traffic jam will be described with reference to the flowchart illustrated in FIG. 19.

Driving information that has been previously received by the receiving part 131 from the driving information management servers 200a and 200b is stored in the driving information DB 121 of the memory part 120 in a state that the driving information received is distributed by the distribution part 132 to a predetermined management unit.

In the step S101, the input part 140 receives an input designating an area and a period in which finding is desired from, for example, the road manager, and moves the process to the step S102. In the present embodiment, as illustrated in FIG. 4, designation is made by enclosing an area from which finding is desired within a rectangle on a road map displayed on the screen.

In the step S102, the control part 130 reads driving information that is in the designated area and period from the driving information stored in the driving information DB 121 of the memory part 120, and moves the process to the step S103.

In the step S103, the classification part 133 classifies the vehicles that are identified by the read driving information and that are in the designated area and period into the first group of vehicles and the second group of vehicles, and moves the process to the step S104.

In the step S104, the calculation part 134 calculates the average speeds of the vehicles classified into the respective groups of vehicles for each road section, and moves the process to the step S105.

In the step S105, the finding part 135 finds road sections in which the difference between the average speeds of the vehicles in both of the groups of vehicles is equal to or less than a predetermined value, and moves the process to the step S106.

In the step S106, the display control part 136 displays that the found road sections are road sections that are at a high occurrence likelihood of an accident or a traffic jam on the screen as illustrated in FIG. 15 to inform, for example, the road manager, and terminates the process.

The apparatus for finding a point to be improved on a road performing the control for finding road sections that are at a high occurrence likelihood of an accident or a traffic jam and displaying the road sections on a road map in this way allows the user to know road sections that are at a high occurrence likelihood of an accident or a traffic jam at a glance. Therefore, for example, the road manager can determine with ease whether a road improvement work for preventing occurrence of an accident or a traffic jam is necessary or not.

What is claimed is:

1. A non-transitory computer-readable recording medium having stored therein a program for finding a point to be improved on a road, the program causing a computer to execute a process, the process comprising:
receiving driving information from a plurality of vehicles, the driving information including information on a position, a time, and a speed; and
finding a road section based on the driving information of a first group of vehicles and the driving information of a second group of vehicles in a predetermined area and a predetermined period, the road section being a road section in which the speed of the vehicles in the second group of vehicles is affected by the vehicles in the first group of vehicles.

2. The non-transitory computer-readable recording medium according to claim 1, wherein the finding is finding the road section in which a difference between an average of the speed of the vehicles in the first group of vehicles and an average of the speed of the vehicles in the second group of vehicles is equal to or less than a predetermined value.

3. The non-transistor computer-readable recording medium according to claim 1, wherein the finding is finding the road section in which a difference between standard deviation of the speed of the vehicles in the first group of vehicles and standard deviation of the speed of the vehicles in the second group of vehicles is equal to or less than a predetermined value.

4. The non-transitory computer-readable recording medium according to claim 1, wherein the finding is finding the road section in which standard deviation of the speed of the vehicles in the second group of vehicles is equal to or greater than a predetermined value.

5. The non-transitory computer-readable recording medium according to claim 1, wherein the process further comprises:
informing that an occurrence likelihood of at least one selected from the group consisting of an accident and a traffic jam is high in the road section found in the finding, when the road section in which the speed of the vehicles in the second group of vehicles is affected by the vehicles in the first group of vehicles is found in the finding.

6. The non-transitory computer-readable recording medium according to claim 1, wherein the vehicles in the first group of vehicles are vehicles that have a speed difference from the vehicles in the second group of vehicles.

7. The non-transitory computer-readable recording medium according to claim 1, wherein the driving information comprises vehicle information, and the vehicles identified by the driving information are classified into the first group of vehicles and the second group of vehicles with reference to the vehicle information.

8. An apparatus for finding a point to be improved on a road, the apparatus comprising a processor configured to execute a process, the process comprising:
receiving driving information from a plurality of vehicles, the driving information including information on a position, a time, and a speed; and
finding a road section based on the driving information of a first group or vehicles and the driving information of a second group of vehicles in a predetermined area and a predetermined period, the road section being a road section in which the speed of the vehicles in the second group of vehicles is affected by the vehicles in the first group of vehicles.

9. The apparatus for finding a point to be improved on a road according to claim 8, wherein the finding is finding the road section in which a difference between an average of the speed of the vehicles in the first group of vehicles and an average of the speed of the vehicles in the second group of vehicles is equal to or less than a predetermined value.

10. The apparatus for finding a point to be improved on a road according to claim 8, wherein the finding is finding the road section in which a difference between standard deviation of the speed of the vehicles in the first group of vehicles and standard deviation of the speed of the vehicles in the second group of vehicles is equal to or less than a predetermined value.

11. The apparatus for finding a point to be improved on a road according to claim 8, wherein the finding is finding the road section in which standard deviation of the speed of the vehicles in the second group of vehicles is equal to or greater than a predetermined value.

12. The apparatus for finding a point to be improved on a road according to claim 8, wherein the process further comprises:
informing that an occurrence likelihood of at least one selected from the group consisting of an accident and a traffic jam is high in the road section found in the finding, when the road section in which the speed of the vehicles in the second group of vehicles is affected by the vehicles in the first group of vehicles is found in the finding.

13. A method for finding a point to be improved on a road, the method comprising:
receiving driving information from a plurality of vehicles, by a processor, the driving information including information on a position, a time, and a speed; and
finding a road section based on the driving information of a first group of vehicles and the driving information of a second group of vehicles in a predetermined area and a predetermined period, by the processor, the road section being a road section in which the speed of the vehicles in the second group of vehicles is affected by the vehicles in the first group of vehicles.

14. The method for finding a point to be improved on a road according to claim 13, wherein the finding is finding the road section in which a difference between an average of the speed of the vehicles in the first group of vehicles and an average of the speed of the vehicles in the second group of vehicles is equal to or less than a predetermined value.

15. The method for finding a point to be improved on a road according to claim 13, wherein the finding is finding the road section in which a difference between standard deviation of the speed of the vehicles in the first group of vehicles and standard deviation of the speed of the vehicles in the second group of vehicles is equal to or less than a predetermined value.

16. The method for finding a point to be improved on a road according to claim 13, wherein the finding is finding the road section in which standard deviation of the speed of the vehicles in the second group of vehicles is equal to or greater than a predetermined value.

17. The method for finding a point to be improved on a road according to claim 13, further comprising:
informing, by the processor, that an occurrence likelihood of at least one selected from the group consisting of an accident and a traffic jam is high in the road section found in the finding, when the road section in which the speed of the vehicles in the second group of vehicles is affected by the vehicles in the first group of vehicles is found in the finding.
